(19) United States
(12) Patent Application Publication
(10) Pub. No.: US 2017/0228989 A1
(43) Pub. Date: Aug. 10, 2017

(54) INFORMATION PROCESSING APPARATUS, INFORMATION PROCESSING SYSTEM, INFORMATION PROCESSING METHOD, AND NON-TRANSITORY STORAGE MEDIUM

(71) Applicant: NEC Corporation, Minato-ku, Tokyo (JP)

(72) Inventors: Mizuto SEKINE, Tokyo (JP); Akira YAJIMA, Tokyo (JP); Yuriko YASUDA, Tokyo (JP)

(73) Assignee: NEC Corporation, Minato-ku, Tokyo (JP)

(21) Appl. No.: 15/502,801

(22) PCT Filed: Sep. 9, 2015
(86) PCT No.: PCT/JP2015/075569

§ 371 Date: Feb. 9, 2017

(30) Foreign Application Priority Data
Sep. 18, 2014 (JP) 2014-190335

(51) Int. Cl. G07G 1/00; H04N 5/247; H04N 5/232; G06Q 20/20; G06Q 20/18

(52) U.S. Cl. CPC G07G 1/0009; G06Q 20/208; G06Q 20/18; H04N 5/23293; H04N 5/247

(57) ABSTRACT

In order to solve the above-described problem, there is provided a self-service POS device (10) including an acquisition unit (11) that acquires a captured image obtained by capturing at least one of a customer involved in an operation of reading product information, a product involved in the reading operation, and a store clerk involved in the reading operation, and a captured image display unit (12) that displays the captured image on a display faced toward the customer.

### TECHNICAL FIELD

The present invention relates to an information processing apparatus, an information processing system, an information processing method, and a program.

### BACKGROUND ART

Self-service point of sales (POS) devices are provided for customers themselves to perform an operation of reading product information. A related art is disclosed in Patent Document 1.

### RELATED DOCUMENT

### Patent Document

[Patent Document 1] Japanese Patent No. 5535508

### SUMMARY OF THE INVENTION

### Technical Problem

In a self-service POS device, a unit for suppressing customer frauds (stealing a product of which the product information has not been read, or the like) is desired. An object of the invention is to provide an unconventional unit for suppressing customer frauds.

### Solution to Problem

According to the invention, there is provided an information processing apparatus including an acquisition unit that acquires a captured image obtained by capturing at least one of a customer involved in an operation of reading product information, a product involved in the reading operation, and a store clerk involved in the reading operation, and a captured image display unit that displays the captured image on a display faced toward the customer.

In addition, according to the invention, there is provided an information processing system including the information processing apparatus, and at least one imaging device that captures an image of at least one of a customer involved in an operation of reading product information, a product involved in the reading operation, and a store clerk involved in the reading operation.

In addition, according to the invention, there is provided an information processing method including an acquisition step of acquiring a captured image obtained by capturing at least one of a customer involved in an operation of reading product information, a product involved in the reading operation, and a store clerk involved in the reading operation, and a captured image display step of displaying the captured image on a display faced toward the customer.

In addition, according to the invention, there is provided a program causing a computer to function as an acquisition unit that acquires a captured image obtained by capturing at least one of a customer involved in an operation of reading product information, a product involved in the reading operation, and a store clerk involved in the reading operation, and a captured image display unit that displays the captured image on a display faced toward the customer.

### Advantageous Effects of Invention

According to the invention, an unconventional unit for suppressing customer frauds is realized.

### BRIEF DESCRIPTION OF THE DRAWINGS

The above-described objects, other objects, features and advantages will be further apparent from the preferred exemplary embodiments described below, and the accompanying drawings as follows.

FIG. 1 is a schematic diagram illustrating an example of a hardware configuration of an apparatus according to the present exemplary embodiment.

FIG. 2 is a schematic diagram illustrating an example of an exterior of a self-service POS device according to the present exemplary embodiment.

FIG. 3 is a schematic diagram illustrating an application example of the self-service POS device according to the present exemplary embodiment.

FIG. 4 is a functional block diagram illustrating an example of the self-service POS device according to the present exemplary embodiment.

FIG. 5 is a functional block diagram illustrating an example of the self-service POS device according to the present exemplary embodiment.

FIG. 6 is a schematic diagram illustrating an example of the display of the self-service POS device according to the present exemplary embodiment.

FIG. 7 is a schematic diagram illustrating an example of the display of the self-service POS device according to the present exemplary embodiment.

FIG. 8 is a schematic diagram illustrating an example of the display of the self-service POS device according to the present exemplary embodiment.

FIG. 9 is a functional block diagram illustrating an example of the self-service POS device according to the present exemplary embodiment.

FIG. 10 is a schematic diagram illustrating an example of the display of the self-service POS device according to the present exemplary embodiment.

FIG. 11 is a functional block diagram illustrating an example of the self-service POS device according to the present exemplary embodiment.

FIG. 12 is a functional block diagram illustrating an example of the self-service POS device according to the present exemplary embodiment.

### DESCRIPTION OF EXEMPLARY EMBODIMENTS

First, an example of a hardware configuration of an apparatus of the present exemplary embodiment will be described. Each unit included in the apparatus of the present exemplary embodiment is constituted by an arbitrary combination of hardware and software on the basis of a central processing unit (CPU), a memory, a program loaded into the memory (including a program which is stored in the memory in advance from when shipping out the device and a program which is downloaded from a storage medium such as a compact disc (CD), or a server or the like on the Internet) of an arbitrary computer, a storage unit such as a hard disk which stores the program, and an interface for network connection. In addition, one skilled in the art can understand that various modifications can be made to examples for the constitution method and device.

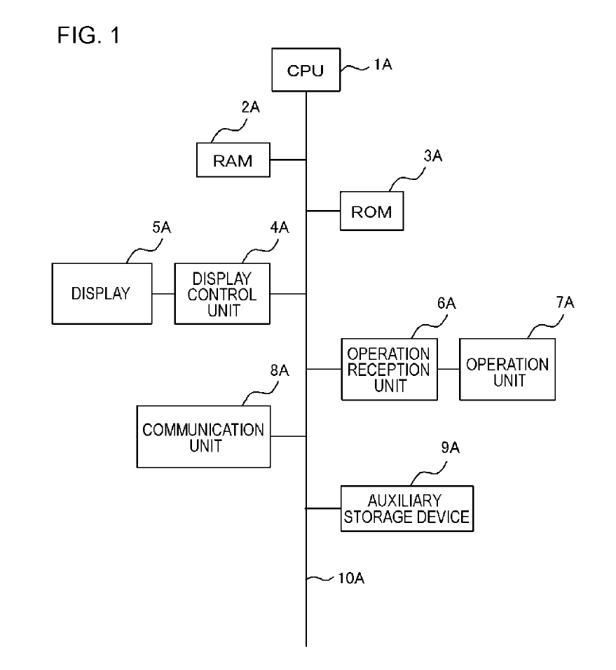

FIG. 1 is a schematic diagram illustrating an example of a hardware configuration of the apparatus of the present exemplary embodiment. As illustrated in the drawing, the apparatus of the present exemplary embodiment includes, for example, a CPU 1A, a random access memory (RAM) 2A, a read only memory (ROM) 3A, a display control unit 4A, a display 5A, an operation reception unit 6A, an operation unit 7A, a communication unit 8A, an auxiliary storage device 9A, and the like which are connected to each other by a bus 10A. It should be noted that, although not shown in the drawing, the device may include an imaging device and other components, such as an input and output interface, a microphone, and a speaker, which are connected to an external device in a wired manner.

The CPU 1A controls the overall computer of the device together with the components. The ROM 3A includes an area in which programs and various application programs for operating the computer, various pieces setting data used when the programs operate, and the like are stored. The RAM 2A includes an area, such as a work area for operating programs, in which data is temporarily stored. The auxiliary storage device 9A is, for example, a hard disc drive (HDD), and can store large-capacity data.

The display 5A is, for example, a display device (alight emitting diode (LED) display, a liquid crystal display, an organic electro luminescence (EL) display, or the like). The display 5A may be a touch panel display which is integrated with a touch pad. The display control unit 4A reads out data stored in a video RAM (VRAM), performs predetermined processing on the read-out data, and then transmits the processed data to the display 5A to thereby perform various screen displays. The operation reception unit 6A receives various operations through the operation unit 7A. The operation unit 7A includes an operation key, an operation button, a switch, a jog dial, a touch panel display, a keyboard, and the like. The communication unit 8A is connected to a network, such as the Internet or a local area network (LAN), in a wired and/or wireless manner to communicate with another electronic equipment item.

Hereinafter, the present exemplary embodiment will be described. It should be noted that, functional block diagrams used in describing the present exemplary embodiment show function-based blocks rather than hardware-based configurations. In the functional block diagrams, although a description is given such that each device is implemented by one apparatus, the implement means thereof is not limited thereto. In other words, each device may be configured to be physically or logically separated. It should be noted that, the same components are denoted by the same reference numerals and signs, and a description thereof will not be repeated.

### First Exemplary Embodiment

First, an outline of the present exemplary embodiment will be described. An information processing apparatus of the present exemplary embodiment is a self-service POS device (self-service POS register) for a customer himself or herself to perform an operation of reading product information. The self-service POS device (self-service POS register) of the present exemplary embodiment includes a display faced toward a customer. The self-service POS device of the present exemplary embodiment may display a captured image obtained by capturing at least one of a customer involved in a reading operation, a product involved in a reading operation, and a store clerk involved in a reading operation, on the display.

According to such a self-service POS device of the present exemplary embodiment, a customer can know that the customer himself or herself or a product which is an object of a reading operation is being captured, by visually perceiving a captured image on a display while the customer performs the reading operation. In addition, it is possible to know the presence of a store clerk involved in the reading operation to perform surveillance or the like. Thereby, it is possible to expect an effect of suppressing customer frauds.

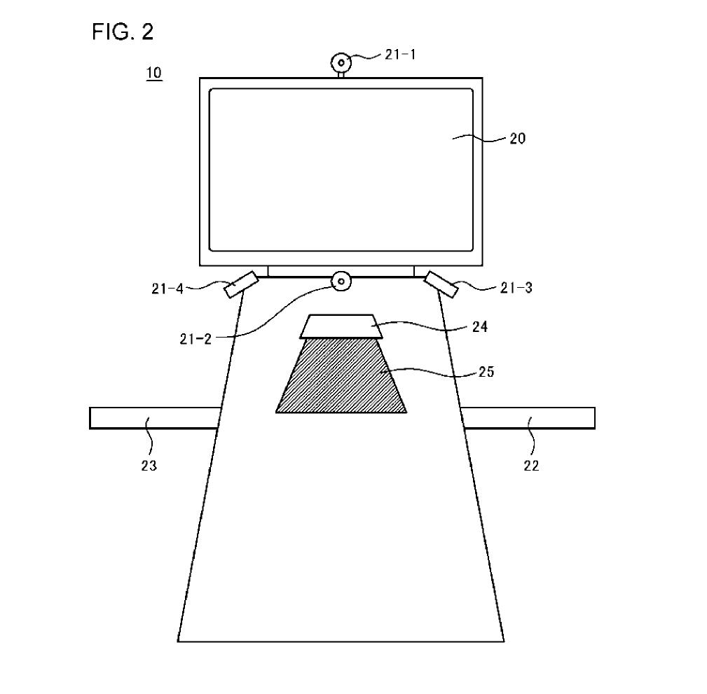

Next, a configuration of the present exemplary embodiment will be described in detail. FIG. 2 is a schematic diagram illustrating an example of an exterior of a self-service POS device 10 according to the present exemplary embodiment. It should be noted that, the external shape and configuration of the self-service POS device 10 shown in the drawing are just examples, and are not limited thereto.

The self-service POS device 10 includes at least a display 20 and a reading unit 24.

The reading unit 24 outputs a laser beam 25 for scanning product information. For example, product information attached to each product in the form of a bar code or the like is held against the laser beam 25 and is scanned, and thus it is possible to make the self-service POS device 10 read the product information.

Information for a checkout process (checkout-related information) is displayed on the display 20. For example, product information read by the reading unit 24, a total amount, and the like are displayed. In addition, a captured image obtained by capturing at least one of a customer involved in a reading operation, a product involved in a reading operation, and a store clerk involved in a reading operation is displayed on the display 20.

It should be noted that, although not shown in the drawing, a display that displays a captured image may be provided, separate from the display having checkout-related information displayed thereon. For example, checkout-related information may be displayed on the display 20 illustrated in FIG. 2. A sub-display smaller than the display 20 may be installed in the vicinity of the display 20. A captured image may be displayed on the sub-display.

The self-service POS device 10 may include a loading counter 22 for products of which the product information has not been read and a loading counter 23 for products of which the product information has been read. A product which is an object (purchase object) of a reading operation and of which the product information has not been read is loaded on the loading counter 22 for products of which the product information has not been read. For example, a basket containing such a product may be loaded thereon. A product which is an object (purchase object) for a reading operation and of which the product information has been read is loaded on the loading counter 23 for products of which the product information has been read. For example, a basket containing such a product may be loaded thereon.

In addition, the self-service POS device 10 may include one or a plurality of imaging devices 21. In a case of the example illustrated in FIG. 2, the self-service POS device 10 includes four imaging devices 21-1 to 21-4.

It should be noted that, the self-service POS device 10 may be configured not to include at least one, for example, all of the imaging devices 21-1 to 21-4. In a case where the self-service POS device 10 does not include all of the imaging devices 21-1 to 21-4, the self-service POS device 10 acquires a predetermined captured image from the imaging device 21 which is present separately from the self-service POS device 10 and displays the acquired image.

The imaging device 21-1 is configured to capture an image of a customer performing a reading operation by using the self-service POS device 10. The imaging device 21-1 is installed, for example, at a position and in a direction for capturing an image of the face of a customer performing a reading operation. The imaging device 21-2 is configured to capture an image of a product for which a reading operation is performed by using the self-service POS device 10. The imaging device 21-2 is installed at a position and in a direction for capturing a product when the product is held against the laser beam 25 to read product information of the product. The imaging device 21-3 is configured to capture an image of a product loaded on the loading counter 22 for products of which the product information has not been read. The imaging device 21-4 is configured to capture an image of a product loaded on the loading counter 23 for products of which the product information has been read.

The self-service POS device 10 can display images captured by the imaging devices 21-1 to 21-4 on the display 20.

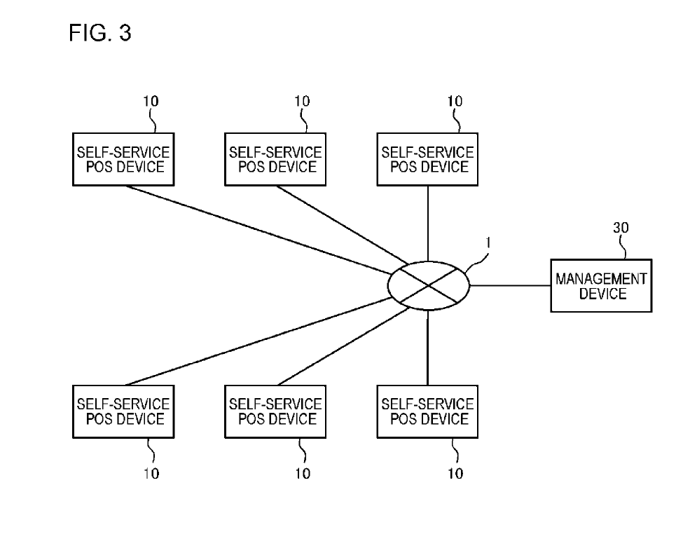

Next, an operational example of the self-service POS device 10 according to the present exemplary embodiment is illustrated in FIG. 3. One or a plurality of self-service POS devices 10 (six self-service POS devices in the drawing) are installed in a predetermined section within a store. The plurality of self-service POS devices 10 are connected to a management device 30 which is operated by a store clerk through a network 1 such as a LAN.

The management device 30 may be installed in the same section as the plurality of self-service POS devices 10, and may be operated by a store clerk involved in the self-service POS device 10, that is, a store clerk who assists a customer performing a reading operation by using the self-service POS device 10 or conducts surveillance. Alternatively, the management device 30 may be installed at a place, for example, a back room with an office, which is different from the section in which the plurality of self-service POS devices 10 are installed. The management device 30 is connected to each of the plurality of self-service POS devices 10 and is configured to be capable of acquiring information regarding each of the self-service POS devices from the self-service POS device 10 and having the information viewed thereon. For example, the management device 30 may be configured to be capable of viewing the same image as an image displayed on the display 20 of each of the self-service POS devices 10.

A store clerk involved in a reading operation is stationed in the section in which the plurality of self-service POS devices 10 are installed. For example, an area where the store clerk is normally positioned (for example, a position at which all of the self-service POS devices 10 can be visually perceived) maybe determined. Although not shown in the drawing, the imaging device 21 configured to capture an image of the store clerk positioned in the area may be provided. For example, the imaging device 21 is installed at a position and in a direction for capturing an image of the face of the store clerk in the area. For example, the management device 30 may be installed in the area where the store clerk is normally positioned, and the imaging device 21 may be installed in the management device 30. For example, the imaging device 21 may be installed at a position and in a direction for capturing an image of the face of a user operating the management device 30.

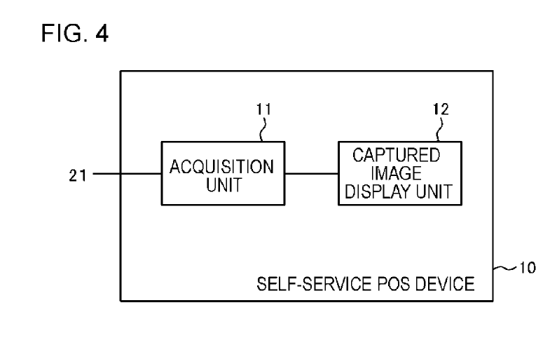

FIG. 4 illustrates an example of a functional block diagram of the self-service POS device 10 according to the present exemplary embodiment. The self-service POS device 10 according to the present exemplary embodiment is configured such that an operation of reading product information is performed by a customer himself or herself. As illustrated in the drawing, the self-service POS device 10 includes an acquisition unit 11 and a captured image display unit 12.

The acquisition unit 11 acquires a captured image obtained by capturing at least one of a customer involved in a reading operation, a product involved in a reading operation, and a store clerk involved in a reading operation. The captured image may be a so-called moving image or may be a still image. In the case of the still image, images that are successively captured at predetermined time intervals (for example, every 0.5 seconds, every second, or the like) are preferably used. It should be noted that, in a case where the captured image is a still image, it is possible to reduce the amount of data by making a frame rate of the still image higher than that of a moving image.

The customer involved in a reading operation is a customer who performs the reading operation by using the self-service POS devices 10. For example, as illustrated in FIG. 2, the imaging device 21-1 installed at a predetermined position of each of the self-service POS devices 10 captures an image of the customer. The product involved in a reading operation is a product which is an object of the reading operation by using the self-service POS devices 10. For example, as illustrated in FIG. 2, at least one of the imaging devices 21-2 to 21-4 respectively installed at predetermined positions of each of the self-service POS device 10 captures an image of the product. The store clerk involved in a reading operation is a store clerk who assists or conducts surveillance of the reading operation which is performed using the self-service POS devices 10 by a customer. For example, as described above using FIG. 3, the imaging device 21 configured to capture an image of an area where the store clerk is supposed to be positioned, for example, the imaging device 21 which is installed in the management device 30 installed in the area and operated by the store clerk captures the store clerk. The acquisition unit 11 acquires images captured by the imaging devices 21 (including the imaging devices 21-1 to 21-4) in real time. The self-service POS device 10 and the imaging device 21 are connected to each other so as to be capable of transmitting and receiving image data by communication in a wired and/or wireless manner.

The captured image display unit 12 displays a captured image, acquired by the acquisition unit 11, on a display faced toward a customer. For example, the captured image display unit 12 displays the captured image on a portion of the display 20 illustrated in FIG. 2. It should be noted that, the captured image display unit 12 can display the captured image acquired by the acquisition unit 11 in a real-time process. The wording “real-time process” as used herein may mean a process of such an extent that an image obtained by capturing a certain customer can be visually perceived by the customer. The real-time process may be a process of such an extent that a customer visually perceiving a captured image feels displayed images are synchronized with the motion of the customer himself or herself, or may be a process of such an extent that the customer feels an operation of the customer himself or herself deviating from displayed images, that is, the customer feels displayed images being slightly delayed.

For example, in a case where the acquisition unit 11 acquires a captured image which is a moving image, the captured image display unit 12 can display the moving image on a display. On the other hand, in a case where the acquisition unit 11 acquires a captured image constituted by a plurality of still images successively captured, the captured image display unit 12 successively displays the plurality of still images in the form of a so-called slide show.

In a case where the acquisition unit 11 acquires a captured image from each of the plurality of imaging devices 21, the captured image display unit 12 may display a plurality of captured images on a multi-window screen having as many windows as the captured images (the number of imaging devices 21). In addition, the captured image display unit 12 may sequentially display a plurality of captured images on windows smaller in number than the captured images (the number of imaging devices 21).

It should be noted that, the captured image display unit 12 can also sequentially display a plurality of captured images on each window of the multi-window screen (for example, the number of windows which is smaller than the number of captured images). In this case, the captured image display unit 12 can control the display so that the same captured image (images captured by the same imaging device 21) is not displayed on the plurality of windows.

If product information is read (for example, reading performed by a reading unit 14 to be described below) in a state where a captured image is not being displayed, the captured image display unit 12 may start displaying the captured image accordingly.

Incidentally, a flow of a series of operations performed by a customer using the self-service POS device 10 includes, for example, the reading of product information, the reception of an input for starting a checkout process, and a checkout process that are performed in this order (first flow), and/or the reading of product information and the reception of an input for stopping an operation that are performed in this order (second flow). The self-service POS device 10 repeats such a flow by being sequentially used by a plurality of customers.

The captured image display unit 12 may continue displaying a captured image until at least one of the reception of an input for starting a checkout process, the end of a checkout process, and the reception of an input for stopping an operation is completed. The display of the captured image may be stopped in response to the completion of at least one of them.

In addition, for example, the display and non-display of a captured image in each self-service POS device 10 may be controlled by a remote operation performed by a store clerk through the management device 30.

According to the above description, a description is also given of a self-service POS system including the self-service POS device 10 and at least one imaging device that captures an image of at least one of a customer involved in an operation of reading product information, a product involved in the reading operation, and a store clerk involved in the reading operation.

According to the present exemplary embodiment described above, it is possible to display a captured image obtained by capturing at least one of a customer involved in an operation of reading product information, a product involved in the reading operation, and a store clerk involved in the reading operation, on a display faced toward the customer performing the reading operation. The customer performing the reading operation can know that the customer himself or herself or a product which is an object of the reading operation is captured, by visually perceiving the captured image. In addition, it is possible to know the presence of a store clerk performing surveillance or the like with respect to the reading operation. Thereby, it is possible to expect an effect of suppressing customer frauds.

It should be noted that, the captured image display unit 12 may display information (characters, a figure, an animation, or the like) for creating an atmosphere as if a captured image is recorded, on a display together with the captured image. Thereby, it is possible to expect to increase an effect of suppressing customer frauds.

### Second Exemplary Embodiment

A self-service POS device 10 according to the present exemplary embodiment displays checkout-related information and a captured image on the same display.

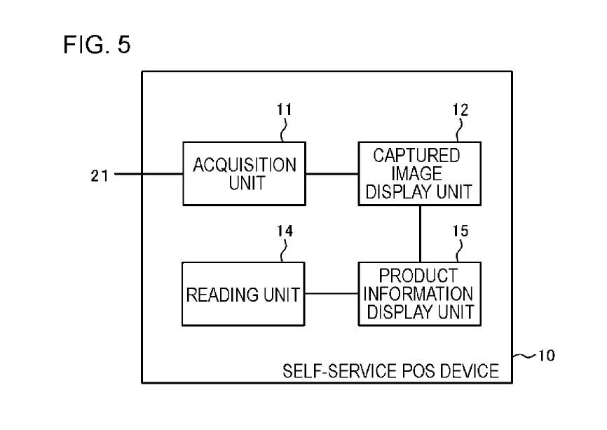

FIG. 5 illustrates an example of a functional block diagram of the self-service POS device 10 according to the present exemplary embodiment. As illustrated in the drawing, the self-service POS device 10 includes an acquisition unit 11, a captured image display unit 12, a reading unit 14, and a product information display unit 15. A configuration of the acquisition unit 11 is the same as that in the first exemplary embodiment.

The reading unit 14 reads product information. For example, the reading unit 14 outputs a laser beam, and reads product information which is attached to each product in the form of a bar code or the like.

The product information display unit 15 displays product information read by the reading unit 14 on a display. The product information display unit 15 displays the product information on, for example, the display 20 illustrated in FIG. 2.

The captured image display unit 12 displays a captured image on the display on which product information is displayed by the product information display unit 15. The captured image display unit 12 displays the captured image on, for example, the display 20 illustrated in FIG. 2. That is, in the present exemplary embodiment, product information and a captured image are displayed on the same display.

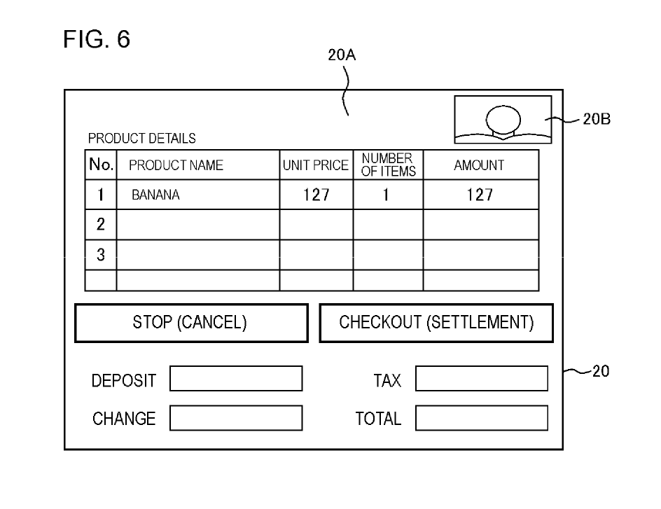

FIG. 6 schematically illustrates an example of a state where product information and a captured image are displayed on the display 20. In a case of the example illustrated in FIG. 6, a window (product information display window 20A) for displaying product information is displayed fully on the display 20.

In the product information display window 20A, a list of pieces of product information read by the reading unit 14 is displayed in columns of product details. Touch areas having information of “stop (cancel)” and “checkout (settlement)” shown therein are areas for receiving a touch operation for stopping a checkout and a touch operation for proceeding to a checkout process, respectively. A deposit amount, a change amount, a tax, and a total purchased amount are displayed in columns of “deposit”, “change”, “tax”, and “total”, respectively.

In a case of the example illustrated in FIG. 6, a captured image display window 20B for displaying a captured image is displayed so as to overlap the product information display window 20A. In a case of such display form, the captured image display window 20B may be displayed, for example, at any one of four corners along the outer circumference of the display 20 so as not to impair the visibility of the product information display window 20A.

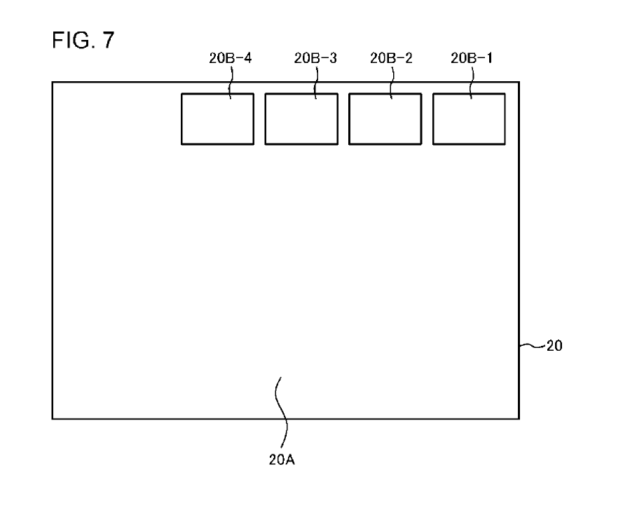

FIG. 7 schematically illustrates another example of a state where the product information display window 20A and the captured image display window 20B are displayed on the display 20. In a case of the example illustrated in FIG. 7, a plurality of captured image display windows 20B are present (captured image display windows 20B-1 to 20B-4), thereby configuring a multi-window screen. Similarly to the example of FIG. 6, the product information display window 20A is fully displayed on the display 20, and the captured image display windows 20B-1 to 20B-4 are displayed thereon in an overlapping manner. In a case of such display form, it is preferable that the plurality of captured image display windows 20B are displayed along the outer circumference of the display 20 so as not to impair the visibility of the product information display window 20A.

It should be noted that, the plurality of captured image display windows 20B-1 to 20B-4 do not need to be lined up along the same side as illustrated in the drawing, and may be disposed, for example, along different sides or may be disposed at four corners of the display 20.

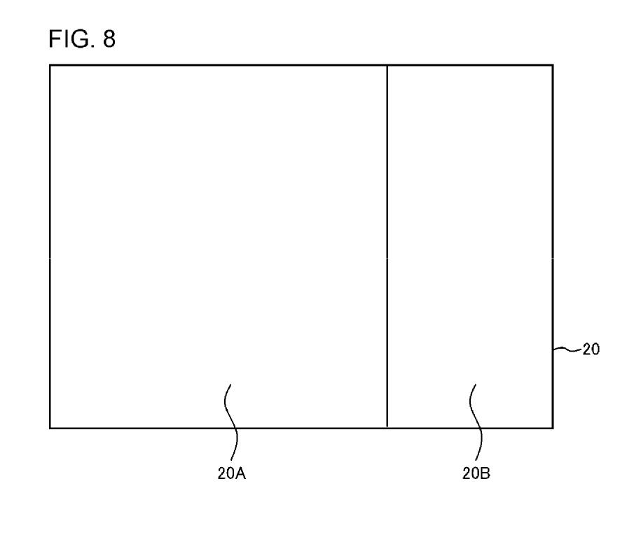

FIG. 8 schematically illustrates another example of a state where the product information display window 20A and the captured image display window 20B are displayed on the display 20. In a case of the example illustrated in FIG. 8, the display 20 is divided into two areas. The product information display window 20A is displayed in one area, and the captured image display window 20B is displayed in the other area. A plurality of captured image display windows 20B may be displayed in the other area. It should be noted that, a method of dividing the display 20 into two areas is not limited to the example in which the display is divided into two of right and left areas illustrated in the drawing, and the display may be divided into two of upper and lower areas or may be divided into two areas in an irregular mode. In a case of the example, it is possible to avoid an inconvenience that a portion (portion overlapping the captured image display window 20B) of the product information display window 20A is not seen due to the captured image display window 20B.

According to the present exemplary embodiment described above, it is possible to realize the same advantageous effects as those in the first exemplary embodiment. In addition, according to the present exemplary embodiment, it is possible to display checkout-related information including product information read by the reading unit 14 and a captured image on the same display.

It is considered that a customer mainly visually perceives a display on which information (checkout-related information) related to a reading operation is displayed during the reading operation. A captured image is displayed on the display, and thus it is possible to make a customer know the presence of the captured image with high probability. It is possible to reduce an inconvenience that the customer does not notice the captured image.

### Third Exemplary Embodiment

A self-service POS device 10 according to the present exemplary embodiment specifies an object which is at least one of a customer and a product in a captured image, and highlights the specified object.

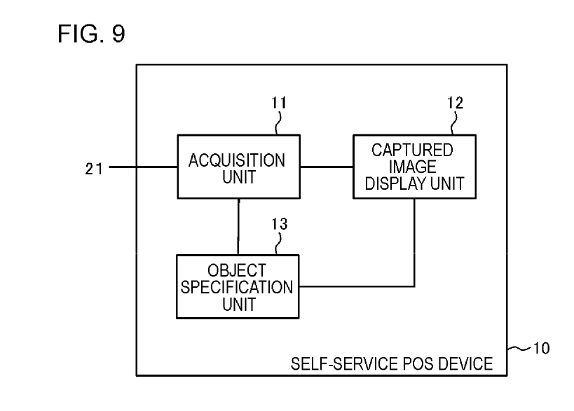

FIG. 9 illustrates an example of a functional block diagram of the self-service POS device 10 according to the present exemplary embodiment. As illustrated in the drawing, the self-service POS device 10 includes an acquisition unit 11, a captured image display unit 12, and an object specification unit 13. It should be noted that, the self-service POS device 10 may further include a reading unit 14 and a product information display unit 15. Configurations of the acquisition unit 11, the reading unit 14, and the product information display unit 15 are the same as those in the first and second exemplary embodiments.

The object specification unit 13 analyzes a captured image and specifies an object which is at least one of a customer and a product in the captured image. Any technique of the related art can be adopted as a means of specifying the object. For example, the face of a person (face of a customer) may be specified in a captured image by using a face identification function with which an imaging device such as a digital camera is equipped. In addition, the object specification unit 13 may hold feature amount (for example, a feature amount of a contour, or the like) of a product considered to be seen in a captured image, and may collate the feature amount and a feature of a contour, which is extracted from the captured image by using an edge detection unit or the like, with each other, thereby specifying the product.

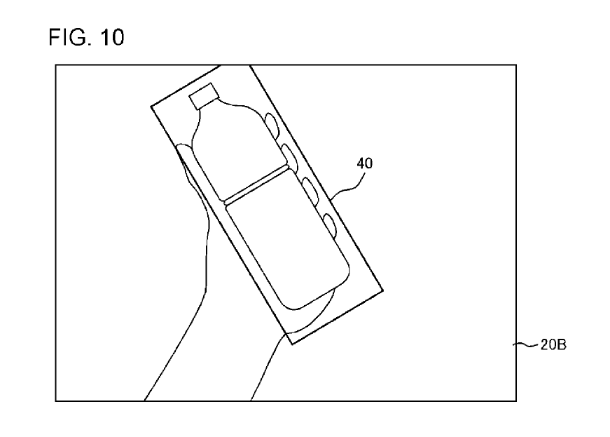

The captured image display unit 12 highlights an object specified by the object specification unit 13. The highlighting means discriminating the object from other portions in a captured image and displaying the object so as to become more conspicuous than the other portions. FIG. 10 illustrates an example of highlighting of the captured image display unit 12. FIG. 10 schematically illustrates an image obtained by extracting only a captured image display window 20B from the entire image on the display. As illustrated in the drawing, a captured image obtained by capturing an image of a product (product involved in a reading operation) which is held by a customer is displayed on the captured image display window 20B. Highlighting is performed by displaying a frame 40 surrounding the product so as to overlap the captured image. It should be noted that, a highlighting method is not limited to surrounding the product by the frame 40, and any of other methods may also be adopted. Also in a case where a customer is specified as an object, highlighting can be performed by using the same method.

As described above, according to the present exemplary embodiment described above, it is possible to realize the same advantageous effects as those in the first and second exemplary embodiments. In addition, an object which is at least one of a customer and a product is highlighted in a captured image displayed toward a customer, and thus it is possible to give an impression to the customer as if the customer himself or herself or the product is specified in the image and is particularly attentively viewed as compared to the other portions in the image. As a result, it is possible to expect an effect of suppressing customer frauds.

### Fourth Exemplary Embodiment

A self-service POS device 10 according to the present exemplary embodiment determines whether or not a store clerk is seen in a captured image acquired from an imaging device 21 which is configured to capture an image of the store clerk involved in a reading operation, and controls display so as not to display a captured image in which the store clerk is not seen.

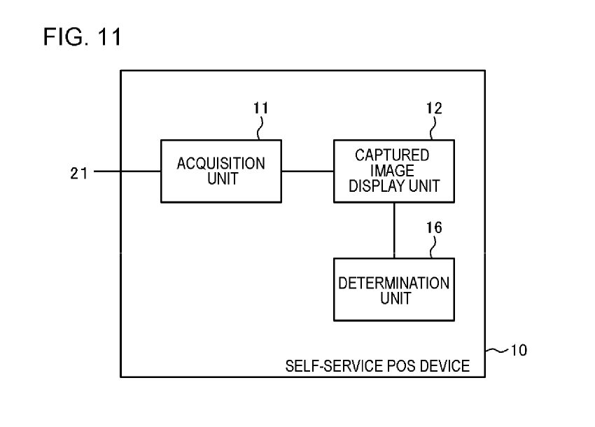

FIG. 11 illustrates an example of a functional block diagram of the self-service POS device 10 according to the present exemplary embodiment. As illustrated in the drawing, the self-service POS device 10 includes an acquisition unit 11, a captured image display unit 12, and a determination unit 16. It should be noted that, the self-service POS device 10 may further include at least one of an object specification unit 13, a reading unit 14, and a product information display unit 15. Configurations of the object specification unit 13, the reading unit 14, and the product information display unit 15 are the same as those in the first to third exemplary embodiments.

The acquisition unit 11 acquires at least a captured image from the imaging device 21 which is configured to capture an image of a store clerk involved in a reading operation. That is, the acquisition unit 11 acquires a captured image from the imaging device 21, which is installed in a direction and at a position for capturing an image of a predetermined area where the store clerk is supposed to be positioned. Since the imaging device 21 is installed (fixed) so as to capture an image of the predetermined area, and thus the imaging device can capture an image of the store clerk in a case where the store clerk is positioned in the area, but cannot capture an image of the store clerk while the store clerk is in another area.

The determination unit 16 determines whether or not a store clerk is seen in a captured image acquired from the imaging device 21.

For example, the determination unit 16 may determine whether or not a store clerk is seen in a captured image by analyzing the captured image. For example, the determination unit 16 determines whether or not a person is seen in a captured image, and may determine that the store clerk is seen in a case where a person is seen and may determine that the store clerk is not seen in a case where a person is not seen. In addition, in a case where the store clerk wears clothes, a hat, a badge, or the like which are distinctive of the store clerks, the determination unit 16 may determine whether or not a person wearing such a distinctive object to thereby determine whether or not the store clerk is seen.

In addition, a human sensor may be installed in a predetermined area where a store clerk involved in a reading operation is supposed to be positioned. The determination unit 16 may determine whether or not a person is present in the predetermined area on the basis of real-time information received from the human sensor. The determination unit 16 may determine that the store clerk is seen in a captured image acquired from the imaging device 21 by the acquisition unit 11 when it is determined that a person is present in the predetermined area, and may determine that the store clerk is not seen in the captured image acquired from the imaging device 21 by the acquisition unit 11 when it is determined that a person is not present in the predetermined area.

In addition, in a case where the management device 30 is installed in a predetermined area where a store clerk involved in a reading operation is supposed to be positioned, the determination unit 16 may acquire login/logout information of the store clerk with respect to the management device 30, and may perform determination on the basis of the information. For example, the determination unit 16 may determine that the store clerk is seen in the captured image acquired from the imaging device 21 by the acquisition unit 11 when the store clerk is logged in to the management device 30. The determination unit 16 may determine that the store clerk is not seen in the captured image acquired from the imaging device 21 by the acquisition unit 11 when the store clerk is not logged in (when the store clerk is logged off) to the management device 30.

The captured image display unit 12 does not display a captured image determined as not capturing a store clerk therein, on a display. For example, the captured image display unit 12 displays a captured image acquired from another imaging device 21 on the display or sets the captured image itself to be in a non-display state.

According to the present exemplary embodiment described above, it is possible to realize the same advantageous effects as those in the first to third exemplary embodiments. In addition, according to the present exemplary embodiment, in a case where it is determined that a store clerk supposed to be originally seen in a captured image is not seen, it is possible to prevent the captured image from being displayed on a display faced toward a customer.

When a captured image having no store clerk, which is supposed to be originally seen, seen therein is displayed toward a customer, a customer knows that the store clerk is not in an area in which the store clerk is originally supposed to be present, in order to conduct surveillance of the entire area. In this case, there is a concern of a fraud being promoted in the meantime. According to the present exemplary embodiment, it is possible to avoid such an inconvenience.

### Fifth Exemplary Embodiment

A self-service POS device 10 according to the present exemplary embodiment identifies a time period between the reading of product information regarding a certain product and the reading of product information regarding the next product, and controls the display of a captured image on the basis of the time period.

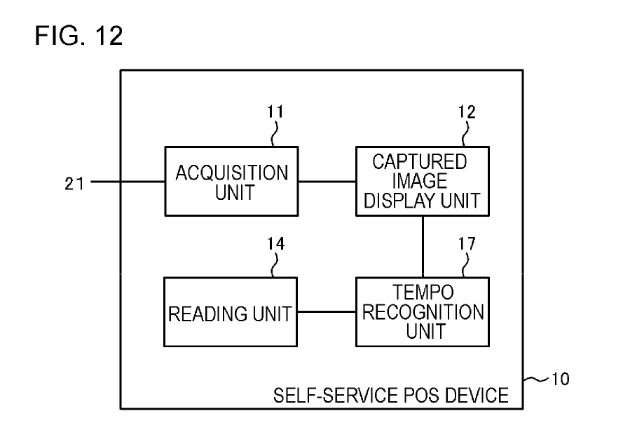

FIG. 12 illustrates an example of a functional block diagram of the self-service POS device 10 according to the present exemplary embodiment. As illustrated in the drawing, the self-service POS device 10 includes an acquisition unit 11, a captured image display unit 12, a reading unit 14, and a tempo identification unit 17. It should be noted that, the self-service POS device 10 may further include at least one of an object specification unit 13, a product information display unit 15, and a determination unit 16. Configurations of the acquisition unit 11, the object specification unit 13, the reading unit 14, the product information display unit 15, and the determination unit 16 are the same as those in the first to fourth exemplary embodiments.

The tempo identification unit 17 identifies a time period between the reading of product information regarding a certain product and the reading of product information regarding the next product (hereinafter, may be referred to as a “reading interval”). The tempo identification unit 17 may continuously identify and store the time period while the customer continues a checkout process.

The captured image display unit 12 controls the display of a captured image on the basis of the time period identified by the tempo identification unit 17.

In a case where the time period is long, there is a possibility that a customer performs an operation which is not related to a reading operation during the checkout process. Consequently, the captured image display unit 12 may control the display and non-display of the captured image on the basis of the time period.

For example, when the captured image display unit 12 detects that the time period is equal to or greater than a predetermined time period, the captured image display unit may start displaying the captured image accordingly. In this case, the captured image is not displayed at the beginning of starting the checkout process, and the display of the captured image is started in response to the detection of the time period being equal to or greater than the predetermined time period. In a case where checkout-related information and a captured image are displayed on the same display, the visibility of the checkout-related information is impaired due to the presence of the captured image. Consequently, it is possible to reduce the disadvantage by displaying a captured image only after the above-described situation is detected, without displaying a captured image at all times.

In addition, the captured image display unit 12 may control the number of captured images to be displayed on a display, that is, the number of captured image display windows 20B, on the basis of the above-mentioned time period.

For example, when the captured image display unit 12 detects that the time period is equal to or greater than the predetermined time period, the captured image display unit may increase the number of captured images accordingly. In this case, for example, one captured image is displayed at the beginning of starting a checkout process, and the number of captured images increases in accordance with the detection of the time period being equal to or greater than the predetermined time period. In a case where checkout-related information and a captured image are displayed on the same display, the visibility of the checkout-related information is impaired due to the presence of the captured image. Consequently, it is possible to reduce the inconvenience by increasing the number of captured images to be displayed in a case where the above-described situation is detected, without displaying a large number of captured images at all times.

In addition, the captured image display unit 12 may control the type of captured image to be displayed on a display, on the basis of the time period.

For example, when the captured image display unit 12 detects that the time period is equal to or greater than the predetermined time period, the captured image display unit may display a captured image obtained by capturing a store clerk and may fix (continue) the display accordingly.

Thereafter, voice which is input by a store clerk through, for example, a microphone included in the management device 30 or a headphone microphone carried by the store clerk is transmitted to the self-service POS device 10, and the self-service POS device 10 may output the voice of the store clerk through a speaker included in the device.

For example, a store clerk can make a question such as “Is there a problem?” or “Can I help you?”. Thereby, it is possible to suppress customer frauds.

It should be noted that, the above-mentioned predetermined time period may be a time period which is determined in advance in common with all customers. However, the speed of a reading operation may vary depending on a customer's age, the number of times of use of the self-service POS device 10, or the like. Consequently, the captured image display unit 12 may determine the predetermined time period for each customer. For example, the predetermined time period may be determined on the basis of reading intervals in a predetermined number of reading operations that are performed by each customer in a checkout process this time. For example, a time period obtained by adding a predetermined delay time period to statistics such as an average value, a maximum value, a minimum value, a most frequent value of a plurality of reading intervals may be determined as the predetermined time period.

In addition, the predetermined time period maybe determined in advance for each age of customers. Age groups of customers may be estimated by analyzing images of customers' faces which are captured by the imaging device 21-1 illustrated in FIG. 2, and the predetermined time period may be determined on the basis of estimation results.

According to the present exemplary embodiment described above, it is possible to realize the same advantageous effects as those in the first to fourth exemplary embodiments.

In addition, according to the present exemplary embodiment, it is possible to start displaying a captured image in response to the detection of a predetermined state, without displaying a captured image at all times. In addition, according to the present exemplary embodiment, it is possible to increase the number of captured images to be displayed, in accordance with the detection of a predetermined state, without displaying a plurality of captured images at all times.

According to the present exemplary embodiment, it is possible to reduce an inconvenience that the visibility of checkout-related information is impaired due to a captured image.

### Sixth Exemplary Embodiment

An information processing apparatus according to the present exemplary embodiment is an apparatus different from a self-service POS device. The other configurations are the same as those in the first to fifth exemplary embodiments. The information processing apparatus according to the present exemplary embodiment is installed near a self-service POS device, for example, for each self-service POS device. The information processing apparatus acquires a captured image obtained by capturing at least one of a customer involved in an operation of reading product information using a corresponding self-service POS device, a product involved in the reading operation, and a store clerk involved in the reading operation (acquisition unit 11), and displays the captured image on a display faced toward the customer (captured image display unit 12). Also in the present exemplary embodiment, it is possible to realize the same advantageous effects as those in the first to fifth exemplary embodiments.

Hereinafter, an example of a reference configuration will be appended.

1. An information processing apparatus including:

an acquisition unit that acquires a captured image obtained by capturing at least one of a customer involved in an operation of reading product information, a product involved in the reading operation, and a store clerk involved in the reading operation; and

a captured image display unit that displays the captured image on a display faced toward the customer.

2. The information processing apparatus according to 1, further including:

an object specification unit that specifies an object, which is at least one of the customer and the product, in the captured image,

wherein the captured image display unit highlights the object.

3. The information processing apparatus according to 1 or 2, further including:

a reading unit that reads the product information; and

a product information display unit that displays the product information read by the reading unit on a display,

wherein the captured image display unit displays the captured image on the display on which the product information is displayed.

4. The information processing apparatus according to any one of 1 to 3,

wherein the acquisition unit acquires the captured image from a plurality of imaging devices,

wherein the captured image display unit displays the plurality of captured images on one or a plurality of windows,

wherein the information processing apparatus further includes:

a reading unit that reads the product information, and

a tempo identification unit that identifies a time period between reading of the product information of a certain product and reading of the product information of a next product, and

wherein the captured image display unit controls the number of windows on the basis of the time period.

5. The information processing apparatus according to any one of 1 to 3,

wherein the acquisition unit acquires the captured image from a plurality of imaging devices, and

wherein the captured image display unit sequentially displays the plurality of captured images on a window.

6. The information processing apparatus according to any one of 1 to 5,

wherein the acquisition unit acquires a captured image from an imaging device installed so as to capture an image of a predetermined area where the store clerk is supposed to be positioned,

wherein the information processing apparatus further includes a determination unit that determines whether or not the store clerk is seen in the captured image acquired from the imaging device, and

wherein the captured image display unit does not display the captured image determined as not capturing the store clerk therein.

7. The information processing apparatus according to any one of 1 to 6, further including:

a reading unit that reads the product information; and

a tempo identification unit that identifies a time period between reading of the product information of a certain product and reading of the product information of a next product,

wherein the captured image display unit controls display and non-display of the captured image on the basis of the time period.

8. The information processing apparatus according to any one of 1 to 7,

wherein a first flow in which reading of the product information, reception of an input for starting a checkout process, and a checkout process are performed in this order and/or a second flow in which reading of the product information and reception of an input for stopping an operation are performed in this order are configured to be repeated, and

wherein the captured image display unit starts displaying the captured image in accordance with the reading of the product information when the reading of the product information is performed after the checkout process or the reception of an input for stopping an operation is performed.

9. The information processing apparatus according to any one of 1 to 8,

wherein the information processing apparatus is a self-service POS device for a customer himself or herself to perform an operation of reading product information.

10. An information processing system including:

the information processing apparatus according to any one of 1 to 9; and

at least one imaging device that captures an image of at least one of a customer involved in an operation of reading product information, a product involved in the reading operation, and a store clerk involved in the reading operation.

11. An information processing method performed by a computer, the method including:

an acquisition step of acquiring a captured image obtained by capturing at least one of a customer involved in an operation of reading product information, a product involved in the reading operation, and a store clerk involved in the reading operation; and

a captured image display step of displaying the captured image on a display faced toward the customer.

11-2. The information processing method performed by the computer according to 11, the method further including:

an object determination step of specifying an object, which is at least one of the customer and the product, in the captured image,

wherein the object is highlighted in the captured image display step.

11-3. The information processing method performed by the computer according to 11 or 11-2, the method further including:

a reading step of reading the product information; and

a product information display step of displaying the product information read in the reading step on a display,

wherein in the captured image display step, the captured image is displayed on the display on which the product information is displayed.

11-4. The information processing method according to any one of 11 to 11-3,

wherein in the acquisition step, the captured image is acquired from a plurality of imaging devices,

wherein in the captured image display step, the plurality of captured images are displayed on one or a plurality of windows,

wherein the information processing method, performed by the computer, further includes:

a reading step of reading the product information, and

a tempo identification step of recognizing a time period between reading of the product information of a certain product and reading of the product information of a next product, and

wherein in the captured image display step, the number of windows is controlled on the basis of the time period.

11-5. The information processing method according to any one of 11 to 11-3,

wherein in the acquisition step, the captured image is acquired from a plurality of imaging devices, and

wherein in the captured image display step, the plurality of captured images are sequentially displayed on a window.

11-6. The information processing method according to any one of 11 to 11-5,

wherein in the acquisition step, a captured image is acquired from an imaging device installed so as to capture an image of a predetermined area where the store clerk is supposed to be positioned,

wherein the information processing method, performed by the computer, further includes a determination step of determining whether or not the store clerk is seen in the captured image acquired from the imaging device, and

wherein in the captured image display step, the captured image determined as not capturing the store clerk therein is not displayed.

11-7. The information processing method performed by the computer according to any one of 11 to 11-6, the method further including:

a reading step of reading the product information; and

a tempo identification step of recognizing a time period between reading of the product information of a certain product and reading of the product information of a next product,

wherein in the captured image display step, display and non-display of the captured image is controlled on the basis of the time period.

11-8. The information processing method according to any one of 11 to 11-7,

wherein a first flow in which reading of the product information, reception of an input for starting a checkout process, and a checkout process are performed in this order and/or a second flow in which reading of the product information and reception of an input for stopping an operation are performed in this order are configured to be repeated, and

wherein in the captured image display step, the captured image is started being displayed in accordance with the reading of the product information when the reading of the product information is performed after the checkout process or the reception of an input for stopping an operation is performed.

11-9. The information processing method according to any one of 11 to 11-8,

wherein the information processing method is performed by a computer of a self-service POS device for a customer himself or herself to perform an operation of reading product information.

12. A program causing a computer to function as:

an acquisition unit that acquires a captured image obtained by capturing at least one of a customer involved in an operation of reading product information, a product involved in the reading operation, and a store clerk involved in the reading operation; and

a captured image display unit that displays the captured image on a display faced toward the customer.

12-2. The program according to 12, causing the computer to further function as:

an object specification unit that specifies an object, which is at least one of the customer and the product, in the captured image,

wherein the captured image display unit is caused to highlight the object.

12-3. The program according to 12 or 12-2, causing the computer to further function as:

a reading unit that reads the product information; and

a product information display unit that displays the product information read by the reading unit on a display,

wherein the captured image display unit is caused to display the captured image on the display on which the product information is displayed.

12-4. The program according to any one of 12 to 12-3,

wherein the acquisition unit is caused to acquire the captured image from a plurality of imaging devices,

wherein the captured image display unit is caused to display the plurality of captured images on one or a plurality of windows,

wherein the program causing the computer to further function as:

a reading unit that reads the product information, and

a tempo identification unit that identifies a time period between reading of the product information of a certain product and reading of the product information of a next product, and

wherein the captured image display unit is caused to control the number of windows on the basis of the time period.

12-5. The program according to any one of 12 to 12-3,

wherein the acquisition unit is caused to acquire the captured image from a plurality of imaging devices, and

wherein the captured image display unit is caused to sequentially display the plurality of captured images on a window.

12-6. The program according to any one of 12 to 12-5,

wherein the acquisition unit is caused to acquire a captured image from an imaging device installed so as to capture an image of a predetermined area where the store clerk is supposed to be positioned,

wherein the program causing the computer to further function as a determination unit that determines whether or not the store clerk is seen in the captured image acquired from the imaging device, and

wherein the captured image display unit is caused not to display the captured image determined as not capturing the store clerk therein.

12-7. The program according to any one of 12 to 12-6, causing the computer to further function as: a reading unit that reads the product information; and

a tempo identification unit that identifies a time period between reading of the product information of a certain product and reading of the product information of a next product,

wherein the captured image display unit is caused to control display and non-display of the captured image on the basis of the time period.

12-8. The program according to any one of 12 to 12-7,

wherein a first flow in which reading of the product information, reception of an input for starting a checkout process, and a checkout process are performed in this order and/or a second flow in which reading of the product information and reception of an input for stopping an operation are performed in this order are programmed so as to be repeated,

wherein the captured image display unit is caused to start displaying the captured image in accordance with the reading of the product information when the reading of the product information is performed after the checkout process or the reception of an input for stopping an operation is performed.

12-9. The program according to any one of 12 to 12-8,

wherein the program is installed in a self-service POS device for a customer himself or herself to perform an operation of reading product information.

The application is based on Japanese Patent Application No. 2014-190335 filed on Sep. 18, 2014, the content of which is incorporated herein by reference.

What is claimed is:

1. An information processing apparatus comprising:
an acquisition unit that acquires a captured image obtained by capturing at least one of a customer involved in an operation of reading product information, a product involved in the reading operation, and a store clerk involved in the reading operation; and
a captured image display unit that displays the captured image on a display faced toward the customer.

2. The information processing apparatus according to claim 1, further comprising:
an object specification unit that specifies an object, which is at least one of the customer and the product, in the captured image,
wherein the captured image display unit highlights the object.

3. The information processing apparatus according to claim 1, further comprising:
a reading unit that reads the product information; and
a product information display unit that displays the product information read by the reading unit on a display,
wherein the captured image display unit displays the captured image on the display on which the product information is displayed.

4. The information processing apparatus according to claim 1,
wherein the acquisition unit acquires the captured image from a plurality of imaging devices,
wherein the captured image display unit displays a plurality of captured images on one or a plurality of windows,
wherein the information processing apparatus further comprises:
a reading unit that reads the product information, and
a tempo identification unit that identifies a time period between reading of product information of a certain product and reading of product information of a next product, and
wherein the captured image display unit controls the number of windows on the basis of the time period.

5. The information processing apparatus according to claim 1,
wherein the acquisition unit acquires the captured image from a plurality of imaging devices, and
wherein the captured image display unit sequentially displays the plurality of captured images on a window.

6. The information processing apparatus according to claim 1,
wherein the acquisition unit acquires a captured image from an imaging device installed so as to capture an image of a predetermined area where the store clerk is supposed to be positioned,
wherein the information processing apparatus further comprises a determination unit that determines whether or not the store clerk is seen in the captured image acquired from the imaging device, and
wherein the captured image display unit does not display the captured image determined as not capturing the store clerk therein.

7. The information processing apparatus according to claim 1, further comprising:
a reading unit that reads the product information; and
a tempo identification unit that identifies a time period between reading of product information of a certain product and reading of product information of a next product,
wherein the captured image display unit controls display and non-display of the captured image on the basis of the time period.

8. The information processing apparatus according to claim 1,
wherein a first flow in which reading of the product information, reception of an input for starting a checkout process, and a checkout process are performed in this order and/or a second flow in which reading of the product information and reception of an input for stopping an operation are performed in this order are configured to be repeated, and
wherein the captured image display unit starts displaying the captured image in accordance with the reading of the product information when the reading of the product information is performed after the checkout process or the reception of an input for stopping an operation is performed.

9. The information processing apparatus according to claim 1,
wherein the information processing apparatus is a self-service POS device for a customer himself or herself to perform an operation of reading product information.

10. An information processing system comprising:
the information processing apparatus according to claim 1; and
at least one imaging device that captures an image of at least one of a customer involved in an operation of reading product information, a product involved in the reading operation, and a store clerk involved in the reading operation.

11. An information processing method performed by a computer, the method comprising:
an acquisition step of acquiring a captured image obtained by capturing at least one of a customer involved in an operation of reading product information, a product involved in the reading operation, and a store clerk involved in the reading operation; and
a captured image display step of displaying the captured image on a display faced toward the customer.

12. A non-transitory storage medium storing a program causing a computer to function as:
an acquisition unit that acquires a captured image obtained by capturing at least one of a customer involved in an operation of reading product information, a product involved in the reading operation, and a store clerk involved in the reading operation; and
a captured image display unit that displays the captured image on a display faced toward the customer.
